(19) United States
(12) Patent Application Publication
(10) Pub. No.: US 2003/0181160 A1
(43) Pub. Date: Sep. 25, 2003

(54) Authentication and provisioning system for subscriber broadcasts

(76) Inventor: Andrew J. Hirsch, Euless, TX (US)

Correspondence Address: HARRINGTON & SMITH, LLP, 4 RESEARCH DRIVE, SHELTON, CT, 06484-6212, US

(21) Appl. No.: 10/104,648

(22) Filed: Mar. 21, 2002

(51) Int. Cl. H04H 1/00

(52) U.S. Cl. 455/3.02; 455/3.06; 455/12.1

(57) ABSTRACT

A subscriber electronic media distribution system including a broadcast transmission reception system and an authentication system. The broadcast transmission reception system includes a receiver. The authentication system is provided for allowing the receiver to descramble a scrambled broadcast transmission received by the receiver. The authentication system includes an authentication server and a receiver geographic position locating system for determining a geographic position of the receiver. When the receiver is determined to be in a predetermined geographic position, the authentication system is adapted to send an authentication signal to the receiver for descrambling the scrambled broadcast transmission.

### BACKGROUND OF THE INVENTION

1. Field of the Invention

The present invention relates to subscriber broadcast transmissions and, more particularly, to a system for authenticating and provisioning reception of encoded broadcast transmissions.

2. Brief Description of Prior Developments

Currently, satellite television providers rely on remote authentication. An encryption/decryption technique is used and the decryption key that reside on a subscriber's satellite receiver can be updated. Once the authentication technique is compromised, review options exist to prevent fraud attempts. In addition, once this method is fraudulently compromised or “hacked”, the satellite television provider must create a new technique that cannot easily be updated, if all, to the existing customer base. This allows hackers to exploit a “hacked” solution with very few, if any, options that the satellite television providers could use to track or disable the “hacked” service. Subscriber authentication relies on “smart card” technology which can and has been defeated.

There is a need for an authentication system, which can be used with a satellite receiver, which cannot be easily defeated, or if defeated, can be used to locate an occurring fraud. There is also a need for a provisioning system which can activate or deactivate display of predetermined sub-groups of broadcast transmissions based upon geographic location of the receiver.

### SUMMARY OF THE INVENTION

In accordance with one aspect of the present invention, a subscriber electronic media distribution system is provided including a broadcast transmission reception system and an authentication system. The broadcast transmission reception system includes a receiver. The authentication system is provided for allowing the receiver to descramble a scrambled broadcast transmission received by the receiver. The authentication system includes an authentication server and a receiver geographic position locating system for determining a geographic position of the receiver. When the receiver is determined to be in a predetermined geographic position, the authentication system is adapted to send an authentication signal to the receiver for descrambling the scrambled broadcast transmission.

In accordance with another aspect of the present invention, a subscriber electronic media distribution system is provided comprising a satellite broadcast transmission reception system and a satellite broadcast transmission provisioning system. The satellite broadcast transmission reception system comprises a satellite signal receiver and a transceiver for transmitting and receiving signals with a provisioning server. The satellite broadcast transmission provisioning system is provided for allowing and restricting display of predetermined satellite broadcast transmissions through the satellite signal receiver. The provisioning system comprises a receiver geographic position locating system for determining a geographic position of the receiver. The satellite broadcast transmission provisioning system is adapted to allow display and restrict display of selected ones of the broadcast transmissions based upon the determined geographic position of the receiver.

In accordance with another aspect of the present invention, a subscriber electronic media distribution system is provided comprising a broadcast transmission receiver system, a geographic locator system and a closed-loop broadcast reception authentication system. The broadcast transmission receiver system comprises a receiver. The geographic locator system is for determining a geographic location of the receiver. The closed-loop broadcast reception authentication system is for allowing display of predetermined broadcast transmissions, received through the receiver system, based upon the geographic location of the receiver determined by the geographic locator system.

In accordance with one method of the present invention, a method of authenticating decoding of a broadcast transmission is provided comprising steps of determining a geographic location of a broadcast receiver; and comparing the determined geographic location of the broadcast receiver to a predetermined authorized location of the broadcast receiver.

In accordance with another method of the present invention, a method of descrambling a broadcast transmission is provided comprising steps of determining a geographic location of a broadcast receiver; and sending an authentication signal to the broadcast receiver when the determined geographic location of the broadcast receiver matches a predetermined authorized geographic location.

### BRIEF DESCRIPTION OF THE DRAWINGS

The foregoing aspects and other features of the present invention are explained in the following description, taken in connection with the accompanying drawings, wherein:

FIG. 1 is a diagram of a subscriber electronic media distribution system incorporating features of the present invention;

FIG. 2 is a block diagram of sub-systems of the subscriber electronic media distribution system shown in FIG. 1;

FIG. 3 is a block diagram of components of the media receiver shown in FIG. 1;

FIG. 4 is a block diagram illustrating that the media receiver is connected to the broadcast provider and the authentication/provisioning system by two communications links;

FIG. 5 is a block diagram illustrating that the media receiver interacts with a receiver geographic position location system of the authentication/provisioning system; and

FIG. 6 is a block diagram illustrating an alternate embodiment of the present invention.

### DETAILED DESCRIPTION OF THE PREFERRED EMBODIMENTS

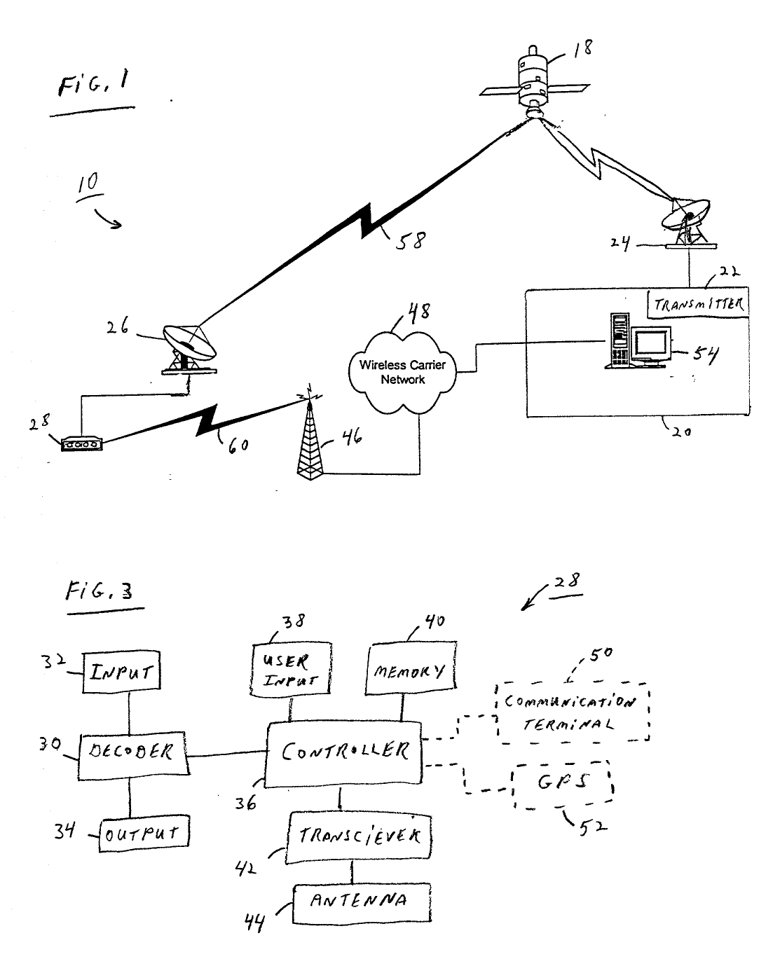

Referring to FIG. 1, there is shown a diagram of a subscriber electronic media distribution system 10 incorporating features of the present invention. Although the present invention will be described with reference to the embodiments shown in the drawings, it should be understood that the present invention can be embodied in many alternate forms of embodiments. In addition, any suitable size, shape or type of elements or materials could be used. Features of the present invention could also be used with a non-subscriber based electronic media distribution system, such as when the system is merely used for its provisioning feature as described below.

Referring also to FIG. 2, the distribution system 10 generally comprises a broadcast transmission system 12, at least one broadcast transmission reception system 14 and an authentication/provisioning system 16. The broadcast transmission system 12 generally comprises a satellite 18 and a broadcast provider 20. The broadcast provider 20 generally comprises a transmitter 22 and a satellite antenna 24. The transmitter 22 and satellite antenna 24 are adapted to transmit broadcast transmissions to the satellite 18. The satellite 18 is adapted to transmit the broadcast transmissions to a plurality of the broadcast transmission reception systems 14, such as broadcast transmission reception systems located at the homes of subscribers. In a preferred embodiment the broadcast transmissions are encoded or scrambled. In a preferred embodiment the broadcast transmissions comprise television and video signals. However, in alternate embodiments, the broadcast transmissions could comprise any suitable type of electronic media, such as radio signals or Internet signals or data signals. In an alternate embodiment, the broadcast transmission system 12 could comprise a non-satellite broadcast transmission system, such as a television cable system.

The broadcast transmission reception system 14 generally comprises a satellite antenna 26 and a media receiver 28. The satellite antenna 26 is adapted to receive the broadcast transmissions from the satellite 18. The media receiver 28 is connected to the satellite antenna 26. The media receiver 28 is also connected to a suitable output device, such as a television or computer (not shown).

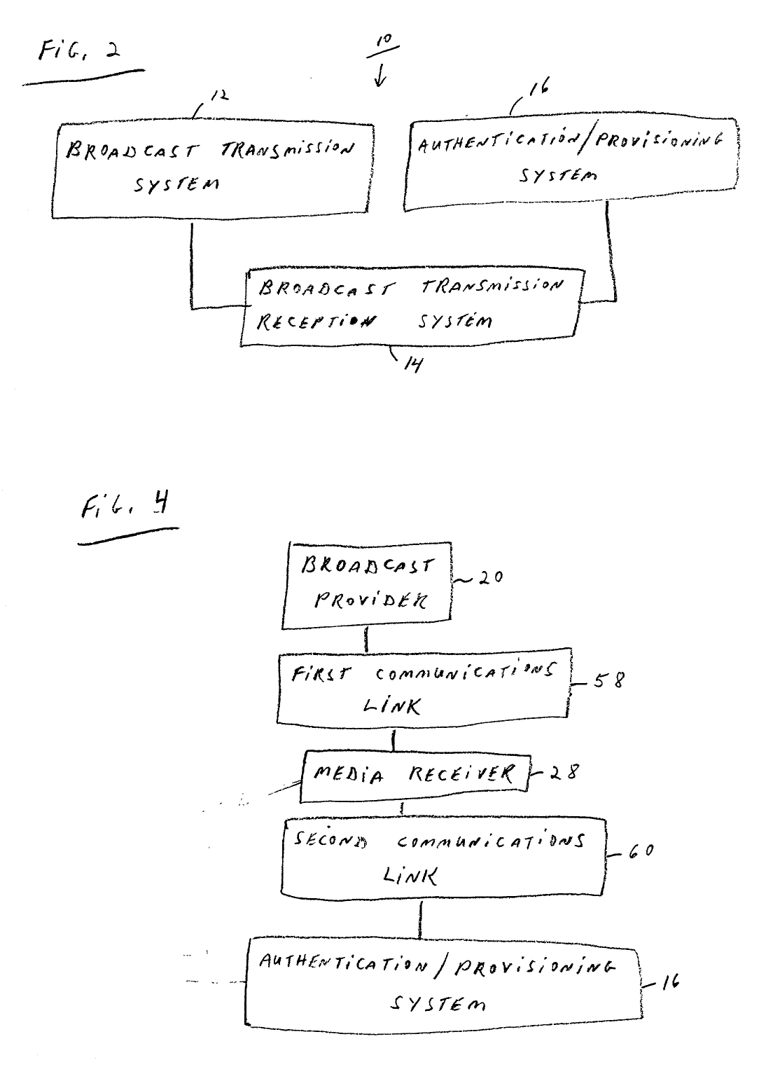

Referring also to FIG. 3, the media receiver 28 generally comprises a decoder 30, an input 32, an output 34, a controller 36, a user input 38, a memory 40, a transceiver 42, and an antenna 44. In alternate embodiments the media receiver could comprise additional or alternative components. The input 32 is connected to the satellite antenna 26. The media receiver 28 is preferably a set top box which can be connected to a television and adapted to descramble or decode scrambled/encoded satellite broadcast transmissions received by the satellite antenna 26. In an alternate embodiment, such as when the media receiver 28 is for a cable television system, the input 32 could be connected to any suitable electronic media input. The output 34 preferably comprises an electrical connector(s) for connecting the media receiver 28 to electronic component, such as a television, VCR, or entertainment system.

The decoder 30 is connected to the controller 36. The controller 36 preferably comprises a printed circuit board having a processor. However, in alternate embodiments, the controller 36 could be comprised of any suitable type of control electronics. The decoder 30 is adapted to selectively decode the scrambled broadcast transmissions received by the satellite antenna 26. The controller 36 controls which of the scrambled broadcast transmissions the decoder 30 is allowed to decode.

The user input 38 is connected to the controller 36. The user input 38 can comprise buttons which can be depressed by the user on the housing of the media receiver 28 and, can comprise an infrared input terminal for receiving signals from a hand held remote control device (not shown). The user input 38 can be used by a user to change channels, such as television channels. The user input 38 can also be used by a user to request a predetermined program or broadcast, such as a pay-per-view event. In alternate embodiments, any suitable type of user input could be provided.

The memory 40 is connected to the controller 36. The memory 40 is adapted to store information such as a media receiver identification number, a setting or list of broadcast channels which the decoder 30 is intended to decode, and any other suitable type of information.

The transceiver 42 is connected to the controller 36. The transceiver 42 is also connected to the antenna 44. The transceiver 42 preferably comprises a radio frequency transceiver similar to a radio frequency transceiver used in a mobile telephone. The transceiver 42 and antenna 44 are adapted to communicate by radio frequency signals with a wireless carrier base station 46 of a wireless carrier network 48 (see FIG. 1).

Preferably, the wireless carrier base station 46 and wireless carrier network 48 comprise an existing mobile telephone/communicator base station and network. However, in alternate embodiments, the base station and network could be designed specifically for use with the present invention; without using an existing network. The base transceiver station 46 can preferably transmit in a forward or downlink direction both physical and logical channels to the media receiver 28 in accordance with a predetermined air interface standard. A reverse or uplink communication path exists from the media receiver 28 to the network 48, and can convey media receiver originated access requests and traffic, such as possible packet data traffic.

The wireless carrier network 48 is preferably connected to a public switched telephone network or PSTN (not shown). The PSTN can, thus, be used to connect the wireless carrier network 48 to the broadcast provider 20. In an alternate embodiment, any suitable type of system can be used to connect the wireless carrier network 48 to the broadcast provider 20, such as an Internet connection.

As seen in FIG. 3, the media receiver 28 could also comprise a communication terminal 50. The communication terminal 50 could comprise a modem adapted to be connected to a telephone line, such as a telephone line connected to a PSTN, or adapted to be connected to a cable communications line. However, the communication terminal 50 might not be provided. Alternatively, any suitable type of additional communication terminal could be provided.

Also as seen in FIG. 3, the media receiver 28 could also comprise a Global Positioning System (GPS) device 52. The GPS device 52 is adapted to receive satellite signals from orbiting GPS satellites and determine the geographic position or location of the media receiver 28. However, in the preferred embodiment, the GPS device 52 is not provided. Instead, the media receiver 28 can use a mobile radio telephone handset geographic position locating system to identify the geographic position of the media receiver as further described below. The GPS device 52 could be provided and used if a mobile radio telephone handset geographic position locating system was not available for use.

As seen in FIG. 2, the authentication/provisioning system 16 is connected to the broadcast transmission reception system 14. Referring also to FIG. 4, a block diagram showing the two communications links 58,60 between the media receiver 28 and the broadcast provider 20 and authentication/provisioning system 16 is shown. The first communications link 58 comprises the satellite communications system shown in FIG. 1. However, in alternate embodiments, the first communications link could comprise any suitable type of communications link. For example, the first communications link 58 could comprise a cable television transmission system or a radio frequency transmission system. The second communications link 60 comprises a radio frequency communications link as shown in FIG. 1. However, in alternate embodiments, the second communications link 60 could comprise any suitable type of communications link. For example, the second communications link could comprise a cable television transmission system and a cable modem or use of public telephone lines and a telephone modem.

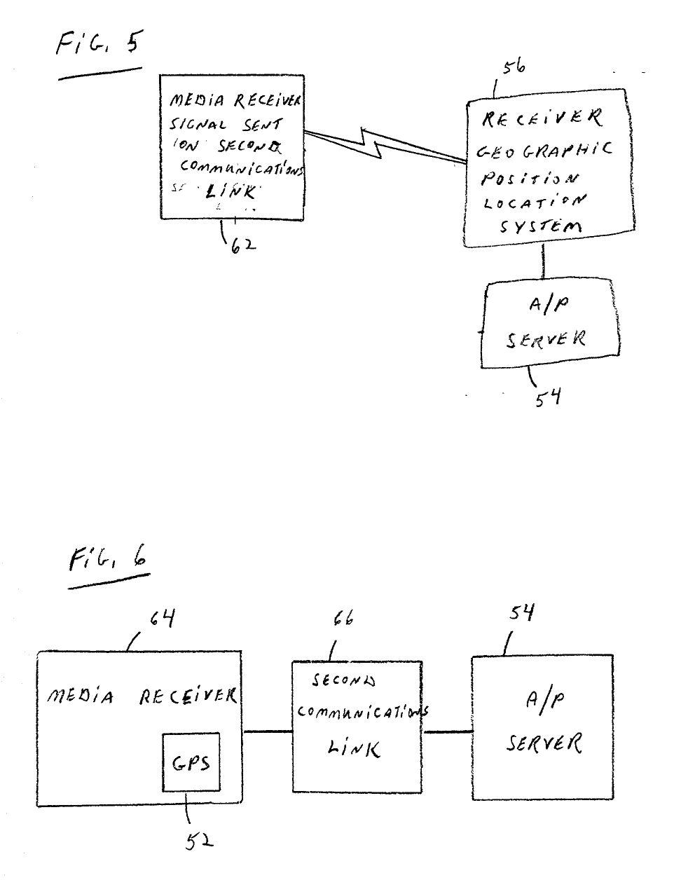

Referring also to FIG. 5, the authentication/provisioning system 16 generally comprises a satellite authentication/provisioning (A/P) server 54 and a receiver geographic position location system 56. The A/P server 54 is preferably located at the broadcast provider 20 (see FIG. 1). However, in alternate embodiments, the A/P server could be located at any suitable location. The A/P server 54 is generally adapted to perform an authentication function and a provisioning function as further described below. However, in alternate embodiments, the A/P server 54 could be adapted to perform only the authentication function or only the provisioning function.

The authentication function generally comprises the A/P server 54 comparing a determined geographic position of the media receiver 28 with a predetermined authorized geographic position for the media receiver 28. The authentication/provisioning system 16 uses the receiver geographic position location system 56 to determine the actual geographic position of the media receiver 28. The receiver geographic position location system 56 preferably comprises use of a mobile radio telephone handset geographic position locating system.

Examples of mobile radio telephone handset geographic position locating systems include the Assisted Global Positioning System (AGPS) and the Enhanced Observed Time Difference (EOTD) system. Features of the present invention could be used with any suitable type of geographic position locating system. However, when the second communications link 60 comprises a pre-established radio frequency communications link, such as used with mobile radio telephone handsets, the present invention can make use of the existing mobile radio telephone handset geographic position locating systems which are already in place. Thus, in order to practice the present invention, the present invention does not need to add a GPS 52 to the media receiver 28.

As seen in FIG. 5, when the second communications link 60 is used by the media receiver 28 to communicate with the broadcast provider 20 in order for the decoder 30 to receive signals to properly decode scrambled satellite broadcast transmissions (block 62), the receiver geographic position location system 56 can quickly identify or determine the geographic position of the media receiver 28. This determined geographic position can then be communicated to the A/P server 54.

The A/P server is preferably adapted to store authorized geographic position information for the media receiver 28. When the subscriber/user of the subscriber electronic media distribution system initially subscribes to the system, a predetermined authorized geographic position for the media receiver 28 can be established and recorded in the A/P server 54. The predetermined authorized geographic position could comprise a range of geographic positions. For example, the range could be a predetermined authorized geographic position ±200 feet. In alternate embodiments, any suitable range could be provided. Any suitable system could be used to initially establish and record the initial predetermined authorized geographic position. Once established, the predetermined authorized geographic position for the media receiver 28 will remain fixed unless the subscriber's account is deactivated or the predetermined authorized geographic position for the media receiver 28 is changed by authorized personnel of the broadcast provider 20, such as if the subscriber moves to a new fixed location (such as a home owner moving to a new house).

The authentication function can occur in at least two modes; a periodic authentication mode and a non-periodic authentication mode. The periodic authentication mode can comprise the A/P server 54 comparing the determined geographic position of the media receiver 28 with the predetermined authorized geographic position on a periodic basis. For example, testing could occur once a month or once a day. Any suitable type of time pattern or schedule for determining and comparing the geographic position of the media receiver 28 could be provided. This position checking or actual position determination could be provided based upon a request automatically sent from the media receiver 28. This could be provided based upon a request sent from the media receiver 28 which is initiated by a signal received from the satellite 18.

The non-periodic authentication mode can comprise the media receiver 28 requesting a service or specific channel decoding access (such as a pay-per-view event) initiated by the user of the media receiver 28. For example, the user could input a request for a pay-per-view event into the user input 38. The request can then be transmitted from the media receiver 28, via the transceiver 42 and antenna 44, to the A/P server 54 by means of the second communications link 60. Thus, the receiver can send a request for an authentication signal to the authentication server. In an alternate embodiment, the request could be transmitted to the A/P server by any other suitable communications link. Once the A/P server 54 receives the request, the authentication/provisioning system can use the receiver geographic position location system 56 to determine if the media receiver 28 is at its predetermined authorized geographic position. The request from the media receiver 28 could be triggered or initiated by the user input 32 and/or could be automatically triggered by a signal sent with the broadcast transmission on the first link 58.

If it is determined that the media receiver 28 is not located at its predetermined authorized position, the broadcast provider 20 can then take appropriate action. Appropriable action might comprise contacting the subscriber to inquire about the discrepancy, and perhaps notifying police authorities of where the media receiver is actually located. In one type of embodiment, if the media receiver 28 does not receive an authentication signal from the A/P server after a predetermined passage of time (such as two months for example), the controller 36 of the media receiver 28 is adapted to deactivate the media receiver. In another type of embodiment, encoding of the broadcast transmissions are changed periodically, and the media receiver 28 must receive a new authentication signal and instructions from the A/P server 54 in order to decode the new differently encoded broadcast transmissions.

As noted above, the authentication/provisioning system 16 can also be used to provide a provisioning function. The provisioning function generally comprises the ability to individually configure each media receiver 28 for decoding or descrambling broadcast transmissions for predetermined groups of channel broadcast transmissions or special broadcast transmissions. For example, the ability to decode satellite television broadcast transmissions are often sold by broadcast providers in various different packages, such as a basic package and premium packages which include more television channels or premium television channels (i.e., HBO™, Showtime™, etc.). As another example, the ability to decode satellite television broadcast transmissions can be configured for descrambling broadcasts of local television stations re-broadcast by the broadcast provider 20 through the satellite broadcast system.

The present invention, based upon the determined geographic location of the media receiver 28, can configure the media receiver 28 for decoding predetermined ones of the broadcast transmissions received at the satellite antenna 26. For example, if the satellite 18 is broadcasting local news programs of New York City and Hartford on two separate channels, and if the media receiver 28 is located in New York City, the A/P server 54 can send an authentication signal to the media receiver 28 to allow the broadcast transmission comprising the New York City local news to be decoded, but not send an authentication signal for the broadcast transmission comprising the Hartford local new to be decoded. Thus, the subscriber in New York City would not be able to see the Hartford local news, but would be able to see the New York City local news.

As another example, the present invention could be used to prevent the media receiver 28 from descrambling broadcast transmissions of premium channels. The present invention could be used for authenticating a sub-group of predetermined ones of a plurality of the broadcast transmissions as a provisioning system for allowing and restricting display of the sub-group based upon geographic position of the receiver.

Referring now to FIG. 6, an alternate embodiment of the present invention is shown. In this embodiment the media receiver 64 comprises a GPS device 52. The media receiver 64 is coupled by a second communications link 66 to the A/P server 54. In this embodiment the second communications link 66 does not need to be a wireless communications link. The second communications link could comprise a wired communications link. The geographic position of the media receiver 64 could be determined by the GPS device 52. The geographic position determined by the GPS device 52 could be transmitted from the media receiver 64 through the second communications link 66 to the A/P server 54.

The present invention can provide a wireless closed loop authentication and provisioning system for satellite distributed media subscribers, such as television, radio, etc. A closed loop authentication can comprises a satellite receiver box which communicates in real time to an authentication server. A wireless transmitter in a satellite television receiver can use encryption technology to communicate to the authenticating server. The present invention could be incorporated into any suitable type of satellite media receiver, such as a Direct TV™ box or a Nokia Media Terminal™.

An authenticating server, perhaps residing at the satellite carrier's location or broadcast provider's location, can periodically communicate with the media receiver (such as a TIVO™ set top box or a Nokia Media Terminal™) via a secure wireless medium, such as General Packet Radio Service (GPRS) or Group special Mobile (GSM). Features of the present invention could be used with any suitable type of wireless data system (for example CDMA and TDMA technology) which has a corresponding position determining system (such as an E-911 system or any other automatic location identification (ALI)). Once on this secure wireless medium, the media receiver can be authenticated when certain programs are subscribed. The exact situation for the authentication would be determined by the satellite carrier. For example, a user requested authentication could be used for pay-per-view movies or premium service movie channels such as HBO™. Further, the programming to be displayed by a media receiver can be provided with an automatic geographically localized authentication and provisioning by the satellite carrier with the use of mobile handset technology (such as GPRS or GSM technology for example) using mobile handset positioning technology (such as EOTD or AGPS or angle-of-arrival (AOA) or TDOA/AOA technology for example) . This can allow for a local TV broadcast to be decoded by the receiver in only a particular geographic area. This location technology can also serve to verify a subscriber's billing address/location for accuracy, such as if fraud is suspected.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A subscriber electronic media distribution system comprising:
a broadcast transmission reception system comprising a receiver; and
an authentication system for allowing the receiver to descramble a scrambled broadcast transmission received by the receiver, the authentication system comprising an authentication server and a receiver geographic position locating system for determining a geographic position of the receiver,
wherein, when the receiver is determined to be in a predetermined geographic position, the authentication system is adapted to send an authentication signal to the receiver for descrambling the scrambled broadcast transmission.

2. A subscriber electronic media distribution system as in claim 1 wherein the broadcast transmission reception system further comprises a satellite antenna coupled to the receiver.

3. A subscriber electronic media distribution system as in claim 2 wherein the receiver comprises a satellite signal descrambler.

4. A subscriber electronic media distribution system as in claim 1 wherein the receiver geographic position locating system comprises a radio frequency transceiver.

5. A subscriber electronic media distribution system as in claim 4 wherein the receiver geographic position locating system comprises an Assisted Global Positioning System (AGPS).

6. A subscriber electronic media distribution system as in claim 4 wherein the receiver geographic position locating system comprises an Enhanced Observed Time Difference (EOTD) system.

7. A subscriber electronic media distribution system as in claim 1 wherein the receiver is adapted to send a request for the authentication signal to the authentication server.

8. A subscriber electronic media distribution system as in claim 1 further comprising a provisioning system for allowing and restricting display of a sub-group of at least one predetermined one of the broadcast transmissions based upon geographic position of the receiver.

9. A subscriber electronic media distribution system comprising:
a satellite broadcast transmission reception system comprising a satellite signal receiver and a transceiver for transmitting and receiving signals with a provisioning server; and
a satellite broadcast transmission provisioning system for allowing and restricting display of predetermined satellite broadcast transmissions through the satellite signal receiver, the provisioning system comprising a receiver geographic position locating system for determining a geographic position of the receiver,
wherein the satellite broadcast transmission provisioning system is adapted to allow display and restrict display of selected ones of the broadcast transmissions based upon the determined geographic position of the receiver.

10. A subscriber electronic media distribution system as in claim 9 wherein the transceiver comprises a radio frequency transceiver.

11. A subscriber electronic media distribution system as in claim 10 wherein the satellite broadcast transmission reception system further comprises a first satellite signal antenna coupled to the satellite signal receiver and a second radio frequency antenna coupled to the transceiver.

12. A subscriber electronic media distribution system as in claim 9 wherein the receiver geographic position locating system comprises an Assisted Global Positioning System (AGPS).

13. A subscriber electronic media distribution system as in claim 9 wherein the receiver geographic position locating system comprises an Enhanced Observed Time Difference (EOTD) system.

14. A subscriber electronic media distribution system as in claim 9 wherein the transceiver is adapted to send a request for an authentication signal to a server of the provisioning system for displaying a predetermined one of the satellite broadcast transmissions.

15. A subscriber electronic media distribution system comprising:
a broadcast transmission receiver system comprising a receiver;
a geographic locator system for determining a geographic location of the receiver; and
a closed-loop broadcast reception authentication system for allowing display of predetermined broadcast transmissions, received through the receiver system, based upon the geographic location of the receiver determined by the geographic locator system.

16. A subscriber electronic media distribution system as in claim 15 wherein the broadcast transmission receiver system further a satellite signal antenna coupled to the receiver.

17. A subscriber electronic media distribution system as in claim 16 wherein the broadcast transmission receiver system further comprises a radio frequency transmitter and a radio frequency antenna, the radio frequency transceiver and radio frequency antenna forming portions of the geographic locator system and the closed-loop broadcast reception authentication system.

18. A subscriber electronic media distribution system as in claim 15 wherein the geographic locator system comprises an Assisted Global Positioning System (AGPS).

19. A subscriber electronic media distribution system as in claim 15 wherein the geographic locator system comprises an Enhanced Observed Time Difference (EOTD) system.

20. A method of authenticating decoding of a broadcast transmission comprising steps of:
determining a geographic location of a broadcast receiver; and
comparing the determined geographic location of the broadcast receiver to a predetermined authorized location of the broadcast receiver.

21. A method as in claim 20 wherein the broadcast receiver comprises a satellite signal receiver and the method of authenticating decoding comprises authenticating whether or not scrabbled satellite signals should be descrambled.

22. A method as in claim 21 further comprising requesting, by the broadcast receiver, an authentication signal from an authentication server.

23. A method as in claim 22 further comprising sending the authentication signal from the authentication server to the broadcast receiver by a non-satellite link.

24. A method as in claim 20 wherein the step of determining a geographic location of the broadcast receiver comprises use of an Assisted Global Positioning System (AGPS).

25. A method as in claim 20 wherein the step of determining a geographic location of the broadcast receiver comprises use of an Enhanced Observed Time Difference (EOTD) system.

26. A method as in claim 20 wherein the step of determining a geographic location of the broadcast receiver comprises use of a mobile radio telephone handset geographic position locating system.

27. A method as in claim 20 further comprising authenticating a sub-group of predetermined ones of a plurality of the broadcast transmission as a provisioning system for allowing and restricting display of the subgroup based upon geographic position of the receiver.

28. A method of descrambling a broadcast transmission comprising steps of:
determining a geographic location of a broadcast receiver; and
sending an authentication signal to the broadcast receiver when the determined geographic location of the broadcast receiver matches a predetermined authorized geographic location.

29. A method as in claim 28 wherein the broadcast receiver comprises a satellite signal receiver and the method of descrambling comprises authenticating whether or not scrabbled satellite signals should be descrambled.

30. A method as in claim 29 wherein the step of sending the authentication signal to the broadcast receiver comprises sending the authentication signal by a non-satellite link.

31. A method as in claim 28 further comprising requesting, by the broadcast receiver, an authentication signal from an authentication server.

32. A method as in claim 28 wherein the step of determining a geographic location of the broadcast receiver comprises use of an Assisted Global Positioning System (AGPS).

33. A method as in claim 28 wherein the step of determining a geographic location of the broadcast receiver comprises use of an Enhanced Observed Time Difference (EOTD) system.

34. A method as in claim 28 wherein the step of determining a geographic location of the broadcast receiver comprises use of a mobile radio telephone handset geographic position locating system.

35. A method as in claim 28 further comprising authenticating a sub-group of at least one predetermined one of a plurality of the broadcast transmission as a provisioning system for allowing and restricting display of the sub-group based upon geographic position of the receiver.
